(19) United States
(12) Patent Application Publication
(10) Pub. No.: US 2023/0286149 A1
(43) Pub. Date: Sep. 14, 2023

(54) ROBOT CONTROL SYSTEM

(71) Applicant: FANUC CORPORATION, Yamanashi (JP)

(72) Inventor: Tomoki Katou, Minamitsuru-gun, Yamanashi-ken (JP)

(21) Appl. No.: 18/006,067

(22) PCT Filed: Aug. 16, 2021
(86) PCT No.: PCT/JP2021/029930

§ 371 Date: Jan. 19, 2023

(30) Foreign Application Priority Data
Aug. 20, 2020 (JP) 2020-139400

(51) Int. Cl. B25J 9/16

(52) U.S. Cl. CPC B25J 9/1656

(57) ABSTRACT

Provided is a robot control system which enables a user to easily understand correspondence between a program for a higher-level controller and an operation program for a robot control device. A robot control system 100 comprises a higher-level controller 20 and a robot control device 50. The higher-level controller 20 includes a control execution unit 22 that transmits, to the robot control device 50, command information indicating an operation command to a robot, position data accompanying the operation command, and name information indicating the name of the position data, according to a control program for controlling the robot. The robot control device 50 includes a program production unit 51 that produces an operation program for the robot on the basis of the received command information and position data, and a name information addition unit 52 that adds the received name to the position data in the operation program.

### FIELD

The present invention relates to a robot control system that controls a robot.

### BACKGROUND

An industrial robot is generally controlled from a robot controller to make a motion by loading a motion program created using a teach pendant or a programming apparatus into the robot controller. In recent years, however, a system that controls an industrial robot by a PLC (Programmable Logic Controller) is also becoming prevalent (see, e.g., PTL 1).

### CITATIONS LIST

### Patent Literature

[PTL 1] WO 2019/180916 A1

### SUMMARY

### Technical Problem

Nowadays, with the widespread use of, e.g., the PLCopen (registered trademark) standard, an improvement in development environment of a PLC program for controlling an industrial robot is also making progress. A robot control system using a PLC generally executes a PLC program so that a motion instruction to a robot is transmitted from the PLC to a robot controller, and uses the robot controller to generate a motion program based on the motion instruction issued from the PLC and control the robot. In such a robot control system, assuming that teaching setting of a robot using a PLC program and motion confirmation in PLC program development are performed, since the PLC program and the motion program generated by the robot controller have different program specifications, it is hard for the user to comprehend the correspondence between the PLC program and the motion program generated by the robot controller, and it therefore takes a long time for. e.g., a check upon the occurrence of an error.

### Solution to Problem

One aspect of the present disclosure provides a robot control system including a host controller and a robot controller connected to the host controller, the host controller including a control execution unit that transmits, to the robot controller, instruction information representing a motion instruction to a robot and position data associated with the motion instruction, as well as name information representing a name of the position data, based on a control program for controlling the robot, and the robot controller including a program generation unit that generates a motion program for the robot, based on the received instruction information and the received position data, and a name information addition unit that adds the name represented by the received name information to the position data included in the motion program.

### Advantageous Effects of Invention

With the above-mentioned configuration, the user can easily comprehend how the control program generated by the host controller and the motion program generated by the robot controller correspond to each other. This makes it possible to efficiently perform an error check and a debug in teaching setting and programming.

These and other objects, features, and advantages of the present invention will become more apparent from the following detailed description of an exemplary embodiment thereof, as illustrated in the accompanying drawings.

### BRIEF DESCRIPTION OF DRAWINGS

FIG. 1 is a block diagram illustrating a configuration of an entire robot control system according to one embodiment.

FIG. 2 is a diagram illustrating an exemplary PLC program when a PLC is used as a host controller.

FIG. 3 is a diagram illustrating a motion program generated by a robot controller in the configuration illustrated in FIG. 2.

FIG. 4 is a diagram illustrating an exemplary CNC program when a CNC is used as the host controller.

FIG. 5 is a diagram illustrating a motion program generated by the robot controller in the configuration illustrated in FIG. 4.

### DESCRIPTION OF EMBODIMENTS

An embodiment of the present disclosure will be described below with reference to the drawings. In the drawings to be referred to, the same or similar reference numerals denote the same or similar components or functional parts. To facilitate understanding, these drawings use different scales as appropriate. Further, the modes illustrated in the drawings are merely examples for carrying out the present invention, which is not limited to the modes illustrated in the drawings.

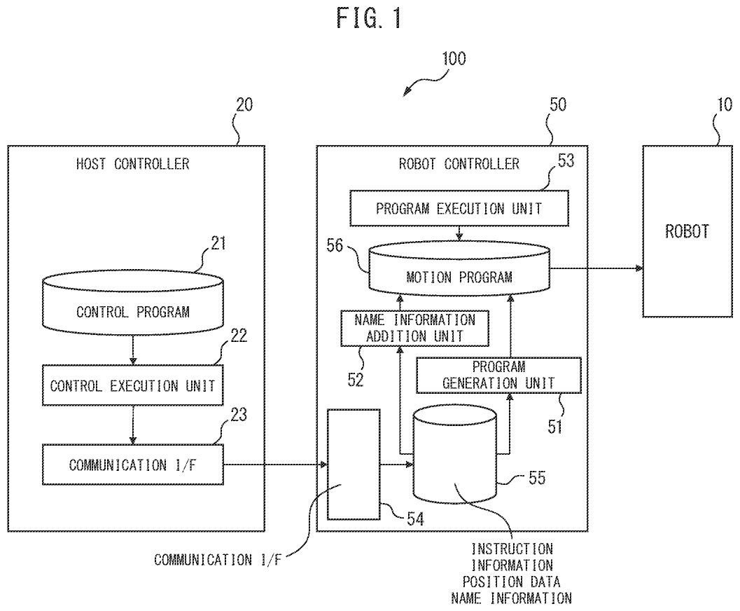

FIG. 1 is a block diagram illustrating a configuration of an entire robot control system 100 according to one embodiment. The robot control system 100 includes a host controller 20, a robot controller 50, and a robot 10, and is configured so that the robot controller 50 that controls the robot 10 and the host controller 20 are communicably connected to each other. The robot control system 100 can create a control program for the robot 10 on the host controller 20. The host controller 20 transmits, to the robot controller 50, a motion instruction to the robot 10 in accordance with the control program for the robot 10 built on the host controller 20. The robot controller 50 generates a motion program for the robot 10 based on the motion instruction transmitted from the host controller 20, and causes the robot 10 to make a motion.

The host controller 20 may have the configuration of a general computer including, e.g., a CPU, a ROM, a RAM, a storage device, an operation unit, a display unit, an I/O interface, and a network interface. The host controller 20 is implemented as, e.g., a PLC (Programmable Logic Controller) or a CNC (Computerized Numerical Controller). As the host controller 20, not only a PLC or a CNC, but also various information processing devices such as a PC can be used. The robot controller 50 may have the configuration of a general computer including, e.g., a CPU, a ROM, a RAM, a storage device, an operation unit, a display unit, an I/O interface, and a network interface. To connect the host controller 20 and the robot controller 50 to each other, a fieldbus, a wired or wireless LAN, or various other networks can be used.

The host controller 20 holds, in the storage device, a control program 21, for controlling the robot 10, built in a software environment running on the host controller 20, as illustrated in FIG. 1. The host controller 20 further includes a control execution unit 22 and a communication interface 23. The control execution unit 22 interprets the control program 21, and transmits, to the robot controller 50 via the communication interface 23, instruction information representing a motion instruction to the robot 10. When the instruction in the control program 21 is implemented as a motion instruction associated with position data, the control execution unit 22 transmits, to the robot controller 50, instruction information representing a motion instruction to the robot 10 and position data associated with the motion instruction, as well as name information representing the name of the position data.

The robot controller 50 includes a program generation unit 51, a name information addition unit 52, a program execution unit 53, and a communication interface 54. In the robot controller 50, the program generation unit 51 generates a motion instruction to the robot 10 based on the instruction information transmitted from the host controller 20, and creates the motion instruction as a motion program 56. In this case, when position data associated with the motion instruction and name information associated with the position data have been transmitted, the name information addition unit 52 adds the name of the position data to the position data as, e.g., a comment text. The program execution unit 53 causes the robot 10 to make a motion by executing the motion program 56 generated by the program generation unit 51.

Specific configurations for two examples in which the host controller 20 is implemented as a PLC and a CNC, respectively, will be described below.

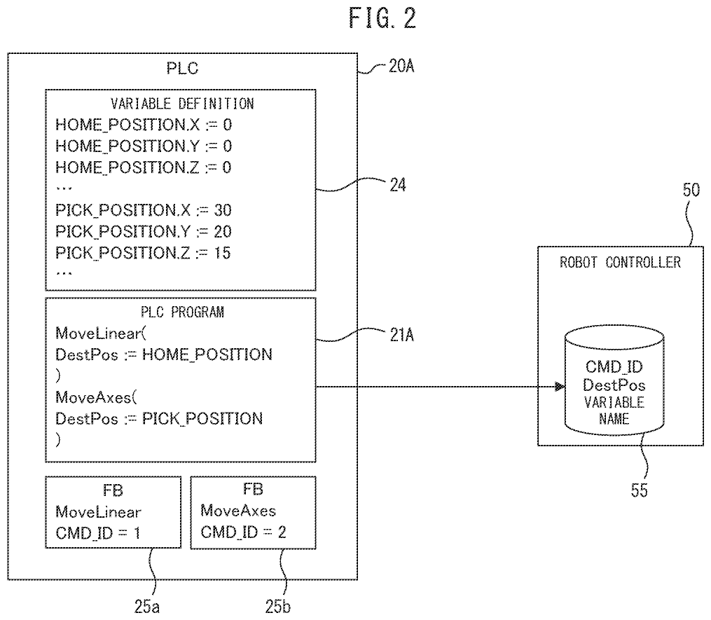

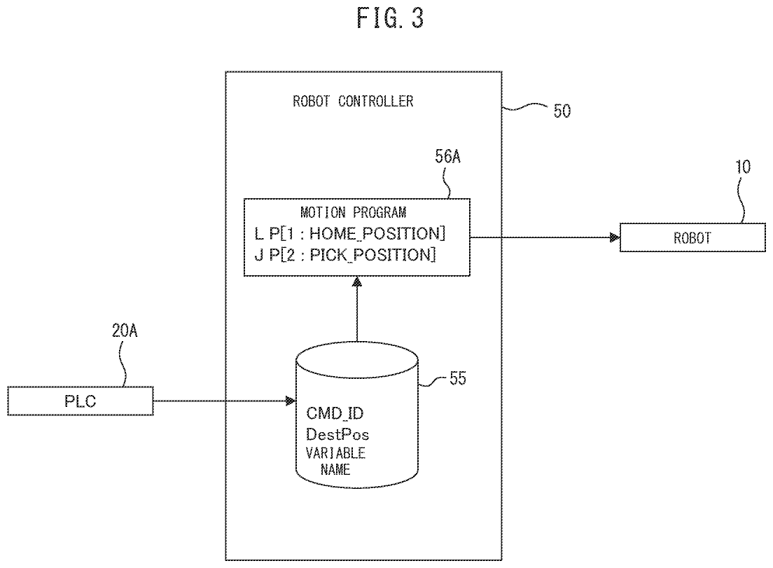

A configuration example when the host controller 20 is implemented as a PLC 20A will be described below with reference to FIGS. 2 and 3. FIG. 2 illustrates an exemplary control program created on the PLC 20A (the control program built on the PLC will also be referred to as a PLC program hereinafter). The control program on the PLC can be created in ladder language or structured text language. A control program created in structured text language will be taken as an example herein. The PLC program illustrated in FIG. 2 includes a variable definition 24, a PLC program body 21A (to be simply referred to as a PLC program 21A hereinafter), and two function blocks (FBs) 25a and 25b.

The variable definition 24 includes two structure variables HOME. POSITION and PICK.POSITION, each of which is formed by three variables X-, Y-, and Z-positions. The values of these variables are respectively set to HOME.POSITION.X=0, HOME.POSITION.Y=0, and HOME.POSITION.Z=0, and PICK.POSITION.X=30, PICK.POSITION.Y=20, and PICK.POSITION.Z=15.

The PLC program 21A includes a MoveLinear function describing an instruction to cause the robot to make a linear motion, and a MoveAxes function describing an instruction to cause the robot to make a joint motion. The motions described by the MoveLinear function and the MoveAxes function are defined in the function blocks (FBs) 25a and 25b, respectively. The MoveLinear function is used to input a structure HOME.POSITION of position data of the robot to an argument DestPos of a target position. With this operation, X=0, Y=0, and Z=0 are commanded as target position data of a MoveLinear instruction (linear motion) for the robot 10. In the function block 25a of the MoveLinear function, a numerical value of 1 is defined to be set as a command ID corresponding to the MoveLinear function. In this case, the control execution unit 22 interprets the function block 25a, transmits “Command ID=1” to the robot controller 50 as instruction information corresponding to the motion instruction MoveLinear, and further transmits the position data (DestPos) to the robot controller 50.

The control execution unit 22 includes ‘HOME.POSITION’ in the data to be transmitted as the variable name of the position data associated with the motion instruction MoveLinear. In other words, in this case, the control execution unit 22 transmits the following data to the robot controller:
Command ID=1
Position Data (X, Y, Z)=(0, 0, 0)
‘HOME.POSITION’

The MoveAxes function is used to input a structure PICK.POSITION of position data of the robot to an argument DestPos of a target position. With this operation, X=30, Y=20, and Z=15 are commanded as target position data of a MoveAxes instruction (linear motion) for the robot 10. In the function block 25b of the MoveAxes function, a numerical value of 2 is defined to be set as a command ID corresponding to the MoveAxes function. In this case, the control execution unit 22 interprets the contents of the function block 25b, transmits “Command ID=2” to the robot controller 50 as instruction information corresponding to the motion instruction MoveAxes, and further transmits the position data (DestPos) to the robot controller 50.

The control execution unit 22 includes ‘PICK.POSITION’ in the data to be transmitted as the variable name of the position data associated with the motion instruction MoveAxes. In other words, in this case, the control execution unit 22 transmits the following data to the robot controller 50:
Command ID=2
Position Data (X, Y, Z)=(30, 20, 15)
‘PICK.POSITION’

The data transmitted from the PLC 20 are stored in, e.g., a primary storage area 55 within the RAM of the robot controller 50. The program generation unit 51 generates a motion program for the robot 10 based on the data transmitted from the PLC 20A. As one example, the robot controller 50 may hold a table associating command IDs and motion instructions with each other, as presented in the following table 1. In this case, the program generation unit 51 can recognize a motion instruction, corresponding to the command ID transmitted from the PLC 20, by looking up this table. In this case, the PLC 20A also holds a table similar to table 1. In the table presented in the following table 1, a linear motion, a joint motion, a pause, and a motion restart are associated with command IDs=1, 2, 3, and 4, respectively.

TABLE 1

| Command ID | Instruction Details |
|---|---|
| 1 | Linear Motion |
| 2 | Joint Motion |
| 3 | Pause |
| 4 | Motion Restart |

Assume that the data transmitted from the PLC 20A indicate a command ID=1. In this case, the program generation unit 51 recognizes, from the command ID=1, that the motion instruction indicates a linear motion. The program generation unit 51 stores position data (0, 0, 0) transmitted together with the command ID=1 in a position register P[1], generates an instruction ‘L P[1]’ for a linear motion of the robot 10, and inserts a text HOME.POSITION representing the name of the position data (0, 0, 0) transmitted together with this position data to the position register P[1] as a comment text. With this operation, the program generation unit 51 generates
‘L P[1:HOME.POSITION]’
   as a statement of a linear motion.

The program execution unit 53 is configured to execute a motion instruction every time a new statement is generated in a motion program 56A as one example, and when the above-mentioned ‘L P[1:HOME.POSITION]’ is inserted into the motion program 56A, the program execution unit 53 linearly moves a controlled portion set in a movable portion of the robot 10 to the target position (home position) set in the position register P[1].

When a command ID=2 is further transmitted from the PLC 20A, the program generation unit 51 recognizes, from the command ID=2, that the motion instruction indicates a joint motion. The program generation unit 51 stores position data (30, 20, 15) transmitted together with the command ID=2 in a position register P[2], generates an instruction ‘J P[2]’ for a joint motion of the robot 10, and inserts a text PICK.POSITION representing the name of the position data (30, 20, 15) transmitted together with this position data to the position register P[2] as a comment text. With this operation, the program generation unit 51 generates
‘J P[2:PICK.POSITION]’
   as a statement of a joint motion.

When the above-mentioned instruction ‘J P[2:PICK.POSITION]’ is inserted into the motion program 56A, the program execution unit 53 moves the controlled portion of the robot 10 to the target position (pick position) set in the position register P[2].

In this manner, a variable name representing position data in the PLC program is inserted into the motion program generated by the robot controller 50 as a comment text representing the position data. In other words, text information assigned to position data in the PLC program is reflected as text information representing the position data in the motion program generated by the robot controller 50. Therefore, the user can easily comprehend how the PLC program and the motion program correspond to each other. Assume, for example, that the position data input from the PLC to the robot controller has an error. In this case, the user may notice the error of the input data as the robot stops at an unintended position, but when a large number of instructions have been input from the PLC to the robot controller, it is difficult to find a statement having the error in the motion program. Even in such a case, when a name common to the variable name in the PLC program has been added to the position data in the motion program, it is possible to easily search for and find position data having the error. In other words, it is possible to efficiently perform an error check and a debug in teaching setting and programming in the robot control system.

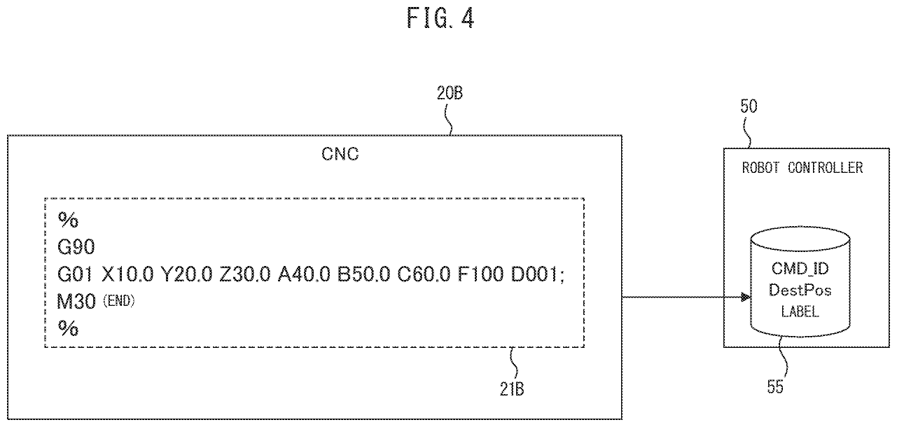

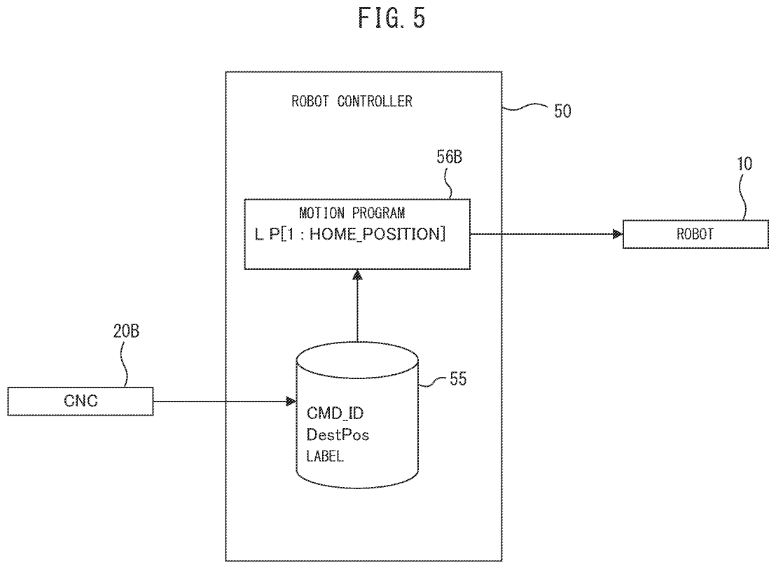

A configuration example when the host controller 20 is implemented as a CNC (Computerized Numerical Controller) 20B will be described below with reference to FIGS. 4 and 5. FIG. 4 illustrates an exemplary control program created on the CNC 20B (the control program built on the CNC will also be referred to as a CNC program hereinafter). A CNC program 21B based on G-code illustrated in FIG. 4 includes the following contents:

G90: An absolute command for designating that coordinates are to be specified as absolute values.

G01: A command issued to make a linear motion. The motion is made at the following position and speed:
Coordinate Position: X_, Y_, Z_
Posture (Angles of Rotation about X-, Y-, and Z-axes): A_, B, C_
Speed: F_

D001: A command for designating that a label (character information) located at position number ‘001’ in a specific area on the memory is to be transmitted to the robot controller 50 as name information for the position represented by X, Y, and Z.

M30: A command representing the end of the main program.

When the CNC program 21B illustrated in FIG. 4 is executed, the control execution unit 22 interprets the CNC program 21B, and comprehends that the instruction G01 issues a linear motion command. The CNC 20B holds the table presented in the above-mentioned table 1, and recognizes a command ID corresponding to the motion instruction by looking up this table. The control execution unit 22 transmits a command ID=1 representing a linear motion, as well as position and posture data set in X, Y, Z, A, B, and C and speed data. The control execution unit 22 further transmits a label assigned to an address specified by ‘D001’ to the robot controller 50 as the name information of the position data. Assume herein that ‘HOME.POSITION’ is set at the address specified by ‘D001’ as the label. In this case, the control execution unit 22 transmits ‘HOME.POSITION’ to the robot controller 50 as the name information of the position data. The command ID, the position data, and the label are temporarily stored in the primary storage area 55 within the robot controller 50.

The program generation unit 51 of the robot controller 50 recognizes, from the command ID=1, that the motion instruction indicates a linear motion. The program generation unit 51 stores position and posture data (X, Y, Z, A, B, C) and (10.0, 20.0, 30.0, 40.0, 50.0, 60.0) transmitted together with the command ID=1 in a position register P[1], generates an instruction ‘L P[1]’ for a linear motion of the robot 10 as a motion program 56B, and inserts a text HOME.POSITION representing the name of the position data transmitted together with the position and posture data to the position register P[1] as a comment text. With this operation, the program generation unit 51 generates ‘L P[1:HOME.POSITION]’

as a statement of a linear motion. The speed specified in the CNC program 21B may be added to the above-mentioned statement as a numerical value for specifying a speed override.

In this manner, a label representing position data in the CNC program 21B is inserted into the motion program 56B in the robot controller 50 as a comment text representing the position data. In other words, text information assigned to position data in the CNC program 21B is reflected as text information representing the position data in the motion program 56B generated by the robot controller 50. Therefore, the user can easily comprehend how the CNC program and the motion program correspond to each other. In other words, it is possible to efficiently perform an error check and a debug in teaching setting and programming, as in the case described above regarding the PLC program.

In the CNC program, since a label freely set by the user in a memory area specified by the instruction code ‘D001’ can be reflected as the name of the position data in the robot controller, user convenience can be improved more.

As described above, according to this embodiment, the user can easily comprehend how the control program generated by the host controller and the motion program generated by the robot controller correspond to each other. This makes it possible to efficiently perform an error check and a debug in teaching setting and programming.

Although the present invention has been described above with reference to exemplary embodiments, it will be appreciated by those skilled in the art that the foregoing and various other changes, omissions, or additions may be made to the above-described embodiments without departing from the scope of the present invention.

An example in which text information (a variable name or a label) itself is transmitted from the host controller to the robot controller as the name information has been given in the above-described embodiment, but in place of such a configuration, identification information (ID) representing a name may be transmitted as the name information. In this case, each of the host controller and the robot controller is configured to hold a table associating the identification information and the text information with each other.

The function (control execution unit) of the host controller illustrated in FIG. 1 may be implemented by executing various types of software by the CPU of the host controller, or may be implemented by a configuration mainly formed by hardware such as an ASIC (Application Specific Integrated Circuit). The functions (the program generation unit, the name information addition unit, and the program execution unit) of the robot controller 50 illustrated in FIG. 1 may be implemented by executing various types of software by the CPU of the robot controller, or may be implemented by a configuration mainly formed by hardware such as an ASIC.

### REFERENCE SIGNS LIST

10 Robot
20 Host controller
21 Control program
22 Control execution unit
23 Communication interface
24 Variable definition
25a, 25b Function block
20A Programmable logic controller
20B Numerical controller
21A PLC program
21B CNC program
50 Robot controller
51 Program generation unit
52 Name information addition unit
53 Program execution unit
54 Communication interface
55 Primary storage area
56, 56A, 56B Motion program
100 Robot control system

1. A robot control system comprising a host controller and a robot controller connected to the host controller,
the host controller comprising
a control execution unit that transmits, to the robot controller, instruction information representing a motion instruction to a robot and position data associated with the motion instruction, as well as name information representing a name of the position data, based on a control program for controlling the robot, and
the robot controller comprising:
a program generation unit that generates a motion program for the robot, based on the received instruction information and the received position data; and
a name information addition unit that adds the name represented by the received name information to the position data included in the motion program.

2. The robot control system according to claim 1, wherein the control execution unit transmits character information representing the name as the name information.

3. The robot control system according to claim 1, wherein
the host controller comprises a programmable logic controller.

4. The robot control system according to claim 3, wherein the control execution unit transmits a variable name, associated with the position data in the control program, as the name information.

5. The robot control system according to claim 1, wherein the host controller comprises a numerical controller.

6. The robot control system according to claim 5, wherein the control execution unit transmits a label, associated with the position data in the control program, as the name information.
